(19) United States
(12) Patent Application Publication
(10) Pub. No.: US 2026/0235000 A1
(43) Pub. Date: Aug. 13, 2026

(54) Tubular Gripping System

(71) Applicant: Rogers Oil Tools, LLC, Lafayette, LA (US)

(72) Inventors: Tommie L. Rogers, Lafayette, LA (US); John William Trahan, Jr., Lafayette, LA (US)

(21) Appl. No.: 19/151,826

(22) PCT Filed: Feb. 6, 2024
(86) PCT No.: PCT/US2024/014603

§ 371 Date: Jul. 29, 2025

Related U.S. Application Data
(60) Provisional application No. 63/444,110, filed on Feb. 8, 2023.

(51) Int. Cl. E21B 19/16; B25B 13/28; B25B 13/50

(52) U.S. Cl. CPC E21B 19/161; B25B 13/28; B25B 13/505

(57) ABSTRACT

A bushing for placement between a tubular and the jaws of a power tong is disclosed. Longitudinal bushing segments are connected together, and have an inner concave surface adapted to engage the outer surface of the tubular. The inner concave surface is non-damaging to the tubular. The jaw dies and teeth engage the outer surface of the bushing segments, force the bushing segments against the tubular, and can thereby transfer torque to the tubular without damaging the outer surface of the tubular.

### CROSS REFERENCE TO RELATED APPLICATIONS

This United States non-provisional patent application claims priority to U.S. provisional patent application Ser. No. 63/444110, filed Feb. 8, 2023, for all purposes. The disclosure of that provisional patent application is incorporated herein by reference, to the extent same is not inconsistent with this non-provisional patent application.

### BACKGROUND—FIELD OF THE INVENTION

Long tubular strings, which may be thousands of feet long, are used in connection with the drilling and servicing of oil and gas wells. Many of such tubular strings comprise multiple sections or “joints” of tubular, connected by threaded connections. The tubulars may have integral connections, in which the male (pin) and female (box) threads are integral with the tube portion. Other tubulars have separate “collars,” which generally comprise two box threaded sections, into which pin sections of adjacent tubulars screw.

For purposes of this patent application, the term “tubulars” is used in its broadest sense, to include tubular goods commonly known as “tubing,” “drill pipe,” “casing,” etc., of any diameter.

Tubular gripping systems, namely tongs, including power tongs, commonly as a power tong unit comprising a power tong and a backup, are used to screw together the threaded connections to the required torque. Depending on the threaded connection, high torque values may be needed. The torque forces are transmitted from the power tong unit to the tubular via tong dies having inwardly directed teeth, which bite into the outer surface of the tubular. High torque requirements may result in the tong die teeth biting into the tubular to an undesirable degree, thereby damaging the tubular, especially with certain types of tubulars made from special alloys, etc.

Prior art tubular gripping systems have issues with gripping tubulars adequately, while not giving rise to tubular damage.

### SUMMARY OF THE INVENTION

The tubular gripping system embodying the principles of the present invention comprises, in one aspect, a multi-segment sleeve or bushing which is removably positioned between the outer surface of the tubular being gripped, and the gripping surface, typically the tong jaw die teeth, of the tong. The inner, typically concave surface of the longitudinal bushing segments may comprise a gripping surface which is non-damaging to the tubular being gripped. In alternative embodiments, the inner concave surface may comprise a surface treatment to enhance gripping of the tubular, for example knurling or similar treatment. It is understood that the inner surface has a concavity which matches the outer diameter of the tubular being gripped. The tong jaw dies are typically convex in cross section shape, and the tong jaw die teeth bite into the outer surface of the bushing segments, forcing the bushing segments radially inward so that the inner concave surface of the segments contact and grip the tubular, then the tong/tong dies can transmit torque to the tubular via the bushing. The bushing segments additionally provide a much larger circumferential gripping surface area than tong dies alone, which bite only in the specific point of contact of the dies; by way of example only, the bushing segments may have a length of 12 inches, therefore providing a gripping surface area some 12 inches along the length of the tubular. The contact force between the bushing segments and the tubular being gripped, being distributed over the entire surface area of the bushing segments, lessens the degree of penetration into the surface of the tubular being gripped.

### BRIEF DESCRIPTION OF THE DRAWINGS

FIG. 1 is a perspective view of the multi-segment bushing embodying the principles of the present invention.

FIG. 2 is another perspective view of the multi-segment bushing embodying the principles of the present invention.

FIG. 3 is an end-on view of the multi-segment bushing embodying the principles of the present invention, as shown in FIGS. 1 and 2, showing the bushing opened up for placement around a tubular.

FIG. 4 is a perspective view of a power tong and backup unit, with a tubular positioned within the throat or gripping area of the power tong unit, and the multi-segment bushing positioned around the tubular between the tubular and the power tong jaw dies.

FIG. 5 is another perspective view of the arrangement shown in FIG. 4.

FIG. 6 is an end-on view of a tubular positioned within the gripping area of a power tong unit, the multi-segment bushing positioned around the tubular, and the power tong dies bearing against the outer surface of the bushing segments.

FIG. 7 is a perspective view of another embodiment of the multi-segment bushing, wherein the bushing segments have an insert section.

FIG. 8 is a cross section view of a bushing segment showing the insert section.

### DESCRIPTION OF THE PRESENTLY PREFERRED EMBODIMENT(S)

An apparatus embodying the principles of the present invention can be described.

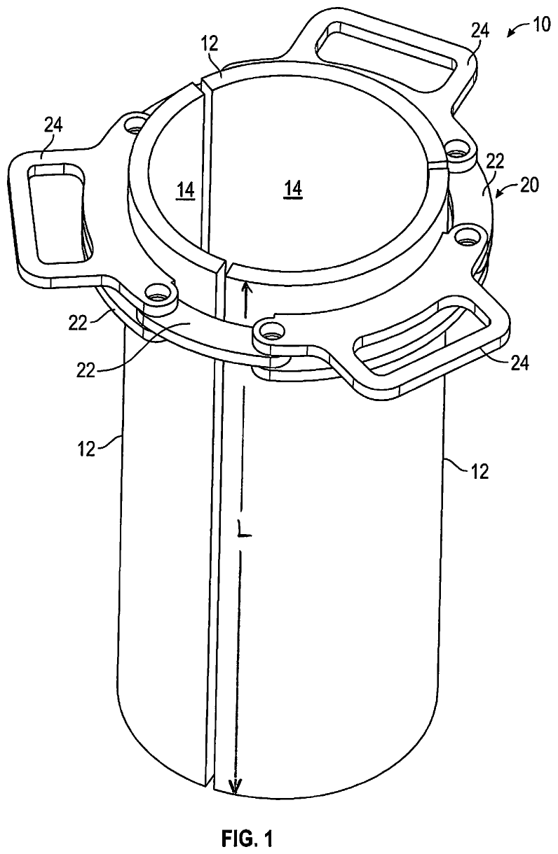

FIG. 1 is a perspective view of multi-segment bushing 10. Bushing 10 may comprise any desired number of longitudinal bushing segments 12; while three bushing segments are shown in the drawing, a greater or lesser number may be used. Dimensions of the bushing segments, and the resulting bushing, may be selected to accommodate and are adapted to a particular tubular size (outer diameter). By way of example only, the bushing segments and bushing may be adapted to and sized to accommodate tubulars ranging from those commonly referred to as “tubing,” with e.g. a 2-⅜″ nominal outer diameter; to drill pipe, with e.g. a 5″ nominal outer diameter; to casing, with nominal outer diameters over a large range, e.g. from 5″ to 9-⅝″. It is understood that these diameter values are by way of example only; the bushing may be used to grip any size tubular, whether small or larger than these exemplary diameters.

Bushing segments 12 may be of any desired length, for placement between the tubular and the tong dies, for example with a length of 12″ to 18″ (shown as dimension L in FIG. 1). It is understood that this length provides an increased contact surface area on the outer surface of the tubular. Bushing segments 12 comprise an inner concave surface 14, adapted to engage the outer surface of tubular 30, as described above.

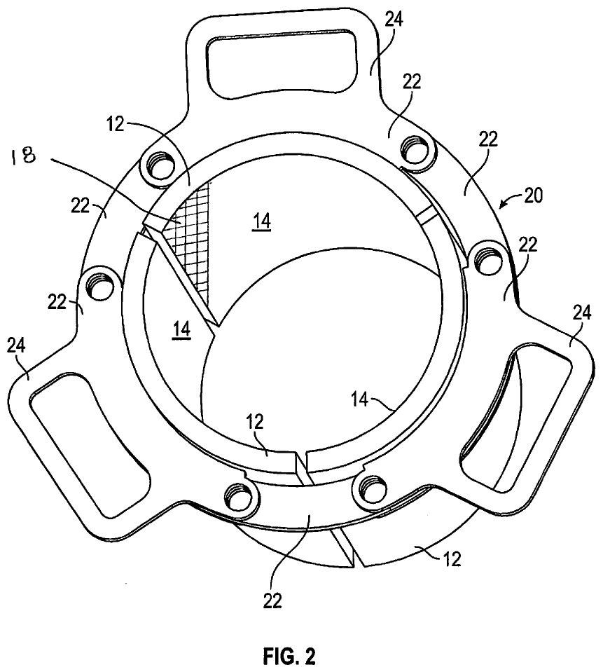

FIG. 2 is another perspective view of bushing 10.

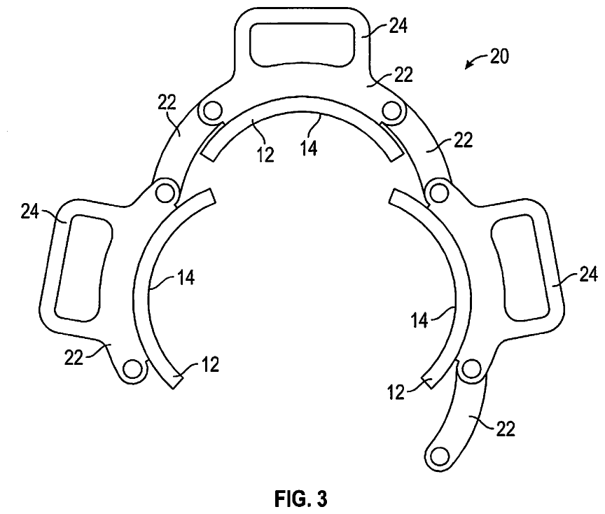

In a preferred embodiment, bushing segments 12 are connected to one another. In one embodiment, link assembly 20 is connected to bushing segments 12 and connects bushing segments 12. One or more of links 22 can be disconnected, so that link assembly 20 can be opened, and thereafter bushing segments 12 and bushing 10 opened up, as shown in FIG. 3, so that bushing 10 may be positioned around a tubular in order to screw together a connection, the link segments locked together (by pins or other suitable connectors) to secure bushing 10 in place, then unlocked and removed from the tubular to permit the tubular string to be run into or pulled out of a wellbore, to the next connection. Link assembly 20 may comprise one or more handles 24 to ease handling.

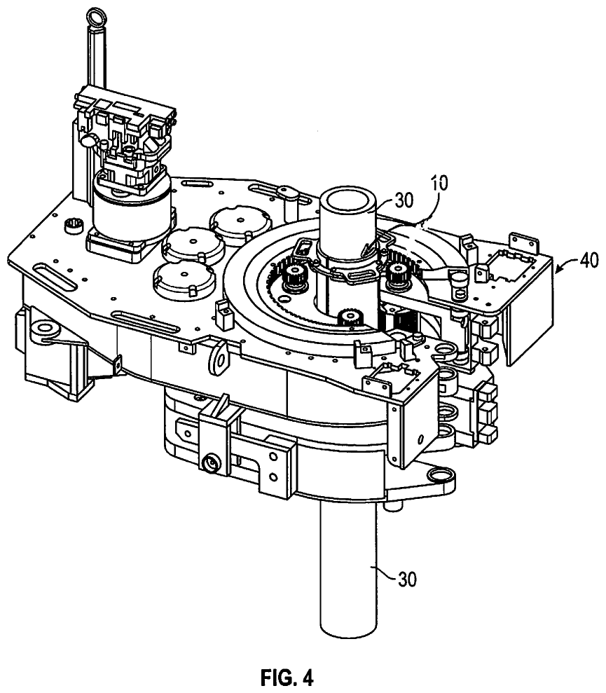

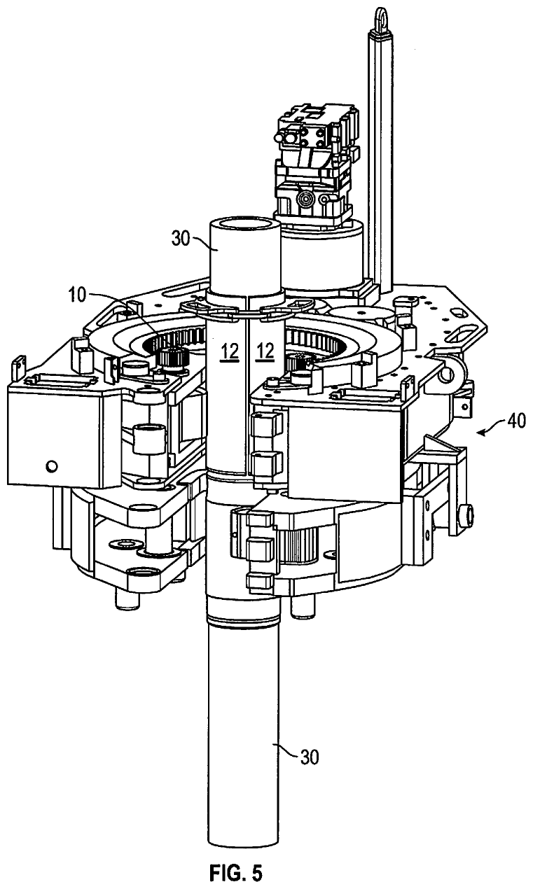

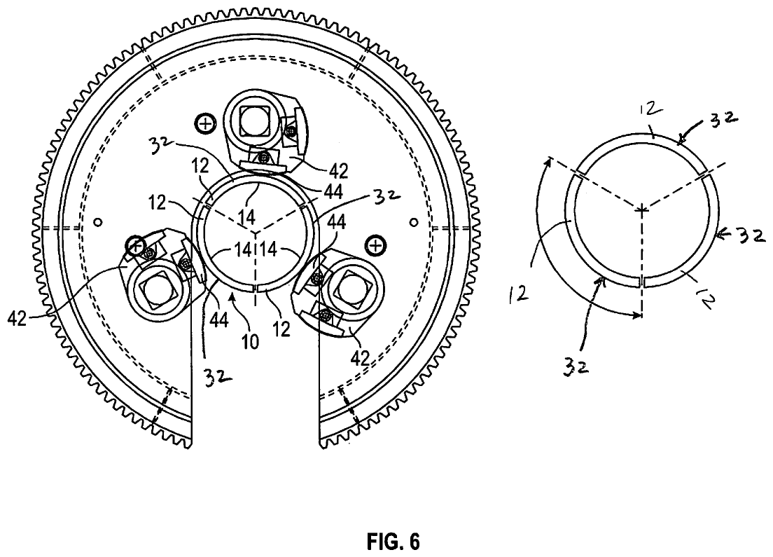

FIG. 4 is a perspective view of a power tong and backup unit 40, which may be referred to as a power tong unit, with a tubular 30 positioned within the gripping area or throat. Bushing 10 is positioned around the outside of tubular 30, between the outer surface 32 of tubular 30 and the tong jaw dies 44. FIG. 6 shows placement of bushing 10 in position around tubular 30, and tong jaw dies 44 held in tong jaws 42 bearing against the outer surface 32 of bushing 10, namely bushing segments 12. FIG. 5 is a view of the power tong unit 40, with tubular 30 and bushing 10 in place, from a different angle than that shown in FIG. 4.

### Use of the Multi-Segment Bushing

From the drawings, in particular FIGS. 4-6 , use of bushing 10 can be readily understood. As a tubular string, comprised of multiple joints of tubular 30, is being run into or pulled from a wellbore, the tubular string is typically set into a set of slips that suspend it from the rig floor. Bushing 10 can then be opened and placed around tubular 30 at a desired location, for example around the tubular above the threaded connection, as shown in FIGS. 4 and 5, then the link segments 22 joined, locking bushing 10 in place on tubular 30. Power tong unit 40 is then moved into position around tubular 30 and functioned in a normal fashion, to engage the tong jaw dies, which are typically, but not exclusively, convex in cross section shape, against the outer surfaces of bushing 10, or bushing segments 12 thereof. Tong dies 44 then bite into bushing 10 or bushing segments 12 (outer surfaces 32 thereof) and force bushing segments 12 radially inward against tubular 30, so that bushing segments 12 engage the tubular, and the power tong unit can then apply the desired torque to the threaded connection, transmitted through the tong jaws and bushing segments.

In other embodiments, a remotely operable deployment/removal mechanism may be used.

It is understood that particular tong jaw/die profiles may generate increasing contact force, as the jaw dies rotate into place with rotation of the tong jaws.

### Materials, Fabrication

Bushing segments 12 can be made of materials known in the relevant trade, for example metal and alloys thereof. The material selection, and inner concave surface of bushing segments 12, may be made in order to minimize marring or other damage to the outer surface of the tubular being gripped. In other embodiments, concave inner surface 14 of bushing segments 12 may have a surface treatment to enhance gripping of tubular 30, e.g. fine teeth, knurling, or other forms, which better enable torque transmission to tubular 30 (in particular, higher torque loads) yet do not damage the outer surface of tubular 30. Such surface treatment is shown as element 18 in FIG. 2. It is to be understood that in FIG. 2 only a small portion of inner concave surface 14 is shown with surface treatment 18, by way of example only and to illustrate one embodiment of the surface treatment.

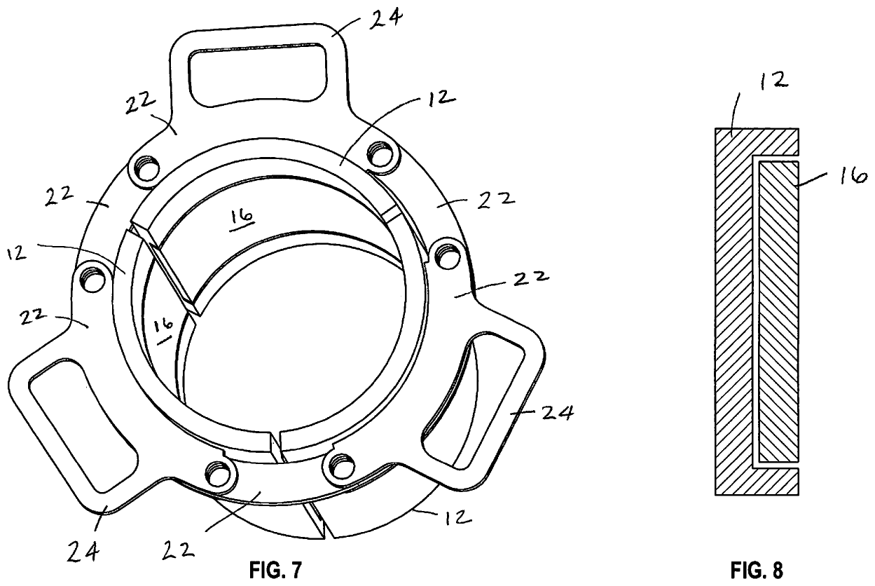

In another embodiment, bushing segments 12 may comprise an insert section 16, seen in FIGS. 7 and 8. In such embodiment, insert section 16 may be of a special material, and/or may have a special surface treatment, to accommodate certain uses. Insert section 16 may be a press fit into bushing segments 12, or may be attached to bushing segments 12 by welding, brazing, adhesives or other means known in the relevant art. Insert section 16 may be replaceable.

Link assembly 20 may be of metals known in the relevant art.

### Conclusion

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

We claim:

1. A tubular gripping system, comprising:
a multi-segment bushing comprising a plurality of connected longitudinal bushing segments, said bushing removably positionable around a tubular between an outer surface of said tubular and a tong jaw die.

2. The tubular gripping system of claim 1, wherein said longitudinal bushing segments are connected by a plurality of links.

3. The tubular gripping system of claim 2, wherein said bushing segments comprise an inner concave surface adapted to the outer diameter of said tubular, and wherein said inner concave surface comprises a non-marking surface.

4. The tubular gripping system of claim 3, wherein said plurality of links comprises a link assembly, said bushing segments connected together by said link assembly, allowing said multi-segment bushing to be opened, positioned around a tubular, then closed and locked in place around said tubular.

5. The tubular gripping system of claim 1, wherein said bushing segments comprise an inner concave surface adapted to the outer diameter of said tubular, and wherein said inner concave surface comprises a surface treatment to enhance gripping of said tubular.

6. The tubular gripping system of claim 2, wherein said longitudinal bushing segments comprise a length in the range of 12 inches to 18 inches.

7. The tubular gripping system of claim 2, wherein said longitudinal bushing segments comprise a length in the range of 6 inches to 12 inches.

8. The tubular gripping system of claim 3, wherein one or more of said longitudinal bushing segments comprises a replaceable insert section.

9. A tubular gripping system, comprising:
a power tong unit comprising a plurality of jaws, said jaws comprising dies having inwardly directed teeth;
a bushing comprising a plurality of linked together longitudinal bushing segments connected by a link assembly, said bushing removably positionable around a tubular positioned in a gripping area of said power tong unit, between an outer surface of said tubular and said jaw dies,
whereby said jaw dies bear against and bite an outer surface of said bushing segments, forcing said bushing segments radially inward to bear against an outer surface of said tubular, whereby torque from said tong is transferred to said tubular.

10. The tubular gripping system of claim 8, wherein said bushing segments comprise an inner concave surface adapted to the diameter of said tubular, and wherein said inner concave surface comprises a surface treatment to enhance gripping of said tubular.

11. The tubular gripping system of claim 9, wherein said jaw dies comprise convex gripping surfaces.

12. The tubular gripping system of claim 9, wherein one or more of said longitudinal bushing segments comprises a replaceable insert section.
